(19) United States
(12) Patent Application Publication
(10) Pub. No.: US 2004/0067168 A1
(43) Pub. Date: Apr. 8, 2004

(54) Temporary separation barrier, container comprising same and method for carrying out a test in said container

(76) Inventors: Frederic Buffiere, Pessac (FR); Christine Betremieux, Bouvines (FR); Jean-Alain Chevaleyre, Pessac (FR); Sandie Menard, Gradignan (FR); Gerard Ovlaque, Bondues (FR); Christophe Vinzia, Ennevelin (FR)

Correspondence Address: Blakely Sokoloff, Taylor & Zafman, 7th Floor, 12400 Wilshire Boulevard, Los Angeles, CA, 90025, US

(21) Appl. No.: 10/433,886

(22) PCT Filed: Dec. 7, 2001
(86) PCT No.: PCT/FR01/03889

(30) Foreign Application Priority Data
Dec. 8, 2000 (FR) 00/16025

(51) Int. Cl. B01J 19/00

(52) U.S. Cl. 422/99; 422/102; 436/34

(57) ABSTRACT

The invention concerns a barrier (2) temporarily separating a reaction container (1) into at least a first compartment (3) wherein a reaction medium comprising an analyte and optionally a reagent is introduced and a second compartment (4) for receiving at least one of the elements among the reagent, the analyte and the reaction product, said barrier (2) being made of a material adapted to shift, by the action of a specific chemical substance, from a first state wherein said material is substantially impermeable to the reaction medium to a second state wherein said material is capable of allowing through at least one of said elements among the reagent, the analyte and the reaction product. The invention also concerns a container comprising such a barrier and a method for carrying out an assay in said container.

The invention relates to a temporary separation barrier of a reaction container, to said reaction container and to a method to conduct a test in the reaction container.

It particularly relates to temporary separation barriers consisting of two compartments intended to receive the reaction medium and certain constituents of the reaction medium, such as the analyte, the reagent and the product of their reaction, respectively.

In a particular example, the reaction takes place in the first compartment and the second compartment is arranged to enable the detection of any reaction, particularly by means of specific bonding of the reaction production with a substance placed in the second compartment.

The purpose of this type of barrier is firstly to isolate the second compartment and, secondly, to enable, under the effect of external forces and at the desired time, the selective passage from the first to the second compartment of certain constituents of the reaction medium such as the analyte, reagent and the product of their reaction.

Such containers are for example intended to conduct biological tests based on the reaction between an analyte present in a biological fluid and a reagent liable to form a complex with said analyte.

This type of test applies typically to screening, in blood or in a blood constituent, for antigens present on the surface of red blood cells using known anti-erythrocyte antibodies (erythrocyte typing) or screening for anti-erythrocyte antibodies using red blood cells on which specific antigens are present and/or fixed.

Physical type separation barriers, for example formed from a plastic membrane or screen, which are arranged between a first and a second compartment of a container, are already known.

This type of barrier involves the drawback of not being modifiable after the reaction medium has been introduced into the first compartment.

Therefore, they must be produced in a very precise manner so as not to enable the diffusion of undesirable constituents in the second compartment, while enabling the diffusion of the desired constituents at the desired time.

The compromise between these two antagonistic constraints generally results in a barrier of mediocre reliability which either allows undesirable constituents to pass, particularly when the reaction medium is poured into the first compartment, or requires the application of a severe external force to enable the passage of the desired constituents.

In addition, this type of embodiment requires provision for a specific shape of barrier according to the shape and/or size of the container.

Separation barriers, for example formed of agars, which are temporary, are also known.

However, this type of barrier involves the drawbacks of a mediocre reliability and a change of phase associated with a change in temperature which may not be desirable for the reaction to take place in the container.

Therefore, the invention aims to remedy all these drawbacks particularly by proposing a separation barrier which can change, in a simple and reliable manner, from a state impermeable to the reaction medium to a state where it is liable to allow certain constituents such as the analyte, reagent or the product of their reaction to pass from the first to the second compartment, at the selected time, without any particular constraint for the reaction for the reaction to take place in the container.

For this purpose, according to a first aspect, the invention proposes a temporary separation barrier of a reaction container consisting of at least one first compartment wherein a reaction medium comprising an analyte and, if applicable, a reagent is introduced and a second compartment intended to receive at least one of the constituents such as the reagent, analyte and the reaction product, said barrier being formed from a substance capable of changing, by means of the action of a specific chemical substance, from a first state wherein said substance is more or less impermeable to the reaction medium to a second state wherein said substance is liable to allow at least one of said constituents, such as the reagent, analyte and the reaction product, to pass.

According to a second aspect, the invention proposes a reaction container comprising a barrier described above, said container taking the form of a micro-well of a micro-titration plate, said micro-well having a U or V shape.

According to a third aspect, the invention proposes a method to conduct a test in a reaction container described above, said method comprising steps consisting of:

introducing the reaction medium into the first compartment;

changing the substance forming the barrier from its first to its second state;

applying an external force capable of enabling the passage of one of the constituents such as the reagent, analyte and the reaction product from the first compartment to the second compartment via the barrier of substance in its second state;

detecting the positive or negative nature of the test.

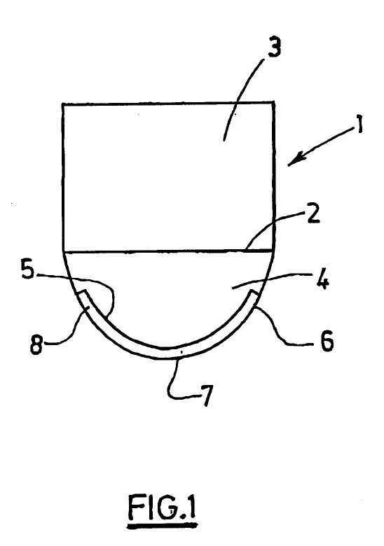

Other aims and advantages of the invention will emerge in the course of the description below with reference to FIG. 1 appended which represents, in a cross-section and a schematic manner, a container comprising a temporary separation barrier according to the invention.

With reference to FIG. 1, a reaction container, for example made of rigid plastic, which is presented in the form of a micro-well of a micro-titration plate, said micro-well having a U-shape, is described.

In a particular example, the container is part of a device comprising eight micro-wells 1 of a micro-titration plate and has a unit capacity of between 300 and 350 μl, a diameter of approximately 6 mm and a height of approximately 8 mm.

In addition, prior to its use, the container 1 may be sealed hermetically by a peel-off film, for example made of special aluminium, so as to prevent the possible contamination of its contents.

The container 1 is divided by a temporary separation barrier 2 into a first compartment 3 wherein a reaction medium comprising an analyte and, if applicable, a reagent is introduced and a second compartment 4 intended to receive at least one of the constituents such as the reagent, analyte and the product of their reaction.

In an alternative embodiment not shown, depending on the type of test to be conducted, the container 1 may be divided into more than two compartments 3, 4.

For example, the container 1 may be divided into three compartments by two separate barriers 2, the first receiving the reaction medium, the second receiving the product of their reaction and containing a second reagent and the third receiving the reaction product to take place in the second compartment.

In the embodiment shown in FIG. 1, the container 1 has a U shape, the opening part forming the first compartment 3 and the base part forming the second compartment 4.

The container 1 is particularly used to enable a possible reaction between an analyte and a reagent.

For this purpose, the barrier 2 is formed from a substance, particularly biological, which, in a first state, is more or less impermeable to the reaction medium so as to isolate the first compartment 3 from the second compartment 4.

In this way, the biological substance, in its first state, acting as a physical barrier with respect to the reaction medium, enables the reaction to be carried out in the first compartment 3 without any risk of diffusion of the reaction medium into the second compartment 4.

If the reaction medium contains no reagent, the purpose of the barrier 2 is to isolate the second compartment 4 for example to subject the reaction medium to a particular treatment.

The purpose of the container 1 is also to enable the passage of certain constituents of the reaction medium in the second compartment 4 in order for example to enable their contact with a substance 5 such as a reagent or a substance enabling the in situ detection of the positive or negative nature of the test.

For this purpose, the biological substance forming the barrier 2 is capable of changing, by means of the action of a specific chemical substance, from the first state to a second state wherein said substance is liable to allow at least one of the constituents such as the reagent, analyte and the product of their reaction to pass.

In a first particular example, the biological substance in its second state enables the detection of the test in the first or in the second compartment 3, 4 as a function of the constituents that it allows to pass.

When it allows the reagent and analyte to pass, detection will be carried out in the first compartment 3 by viewing the possible presence of the reaction product.

When it allows at least the reaction product to pass, detection will be carried out in the second compartment 4 by viewing the possible presence of the reaction product.

In the latter case, a substance 5 capable of binding specifically with the reaction product may be placed in the second compartment 4, for example by being fixed on more or less the entire curved internal wall 6 of the base part 7 of the container 1.

This embodiment is particularly desirable when the biological substance does not allow only the reaction product to pass, but the reaction product and the reagent or analyte, in order to enable viewing of the presence of the reaction product by specific fixation of said product onto the substance 5.

In an alternative embodiment, the second compartment 4 may be filled with the biological substance forming the barrier 2 such that it is also used to protect the substance 5 capable of binding specifically with the reaction product.

In a second particular example, the container 1 enables a chain reaction to be carried out by providing a second reagent to react with the reaction product in the second compartment 4.

In an alternative embodiment of this example, it is possible not to introduce a reagent into the first compartment 3 but to place it in the barrier 2 and/or in the second compartment 4.

In this way, only the biological fluid is introduced into the first compartment 3 and after a possible treatment, at least the analyte passes through the barrier 2 in its second state in order to be placed in contact with the reagent.

This embodiment makes it possible to place the reagent and the analyte in contact at a given time and, if required, with determined kinetics, when the reagent is placed in the barrier 3.

In a third particular example, the second compartment comprises no reagent or specific substance and the biological substance in its second state only serves as a filter between the constituents of the reaction medium.

According to one embodiment, the barrier also comprises the specific chemical substance capable of changing the substance from its first to its second state.

In this embodiment, radiation may initiate, at the desired time, the action of the chemical substance on the substance so as to change it from its first to its second state.

In other embodiments not shown, it is possible to envisage other shapes of container 1, for example a V-shape, of the containers 1 wherein the surface 6 on which the substance 5 is fixed is convex in shape, or that the two compartments 3, 4 are not arranged vertically but transversally, for example.

An embodiment of a container 1 intended to enable the generation and detection of a reaction between an analyte present in a biological fluid, particularly blood or a blood constituent such as a plasma or a serum, and a reagent, are described below.

In this type of reaction, the biological fluid and the reagent comprise protein constituents and/or blood cells.

According to a first use, the purpose of the analysis is to detect the presence of a particular blood cell in the biological fluid. In this case, the reagent, which is able to bind specifically with the blood cell to be detected to form a complex with it is in protein form.

A particular example of such an analysis is when the analyte is a red blood cell comprising a blood group antigen and the reagent comprises a known antibody which is liable to bind with said antigen. This analysis particularly makes it possible to determine the group or phenotype of the red blood cell.

In the description, the terms ‘blood cell’ and ‘complex’ respectively refer to the cellular constituents of the biological fluid or the reagents and the complexes formed by specific bonds with said constituents.

According to a second use, the purpose of the analysis is to detect the presence of a particular protein constituent in the biological fluid. In this case, the reagent, which is able to bind specifically with the protein constituent to be detected to form a complex with it is in the form of a blood cell.

A particular example of such an analysis is when the reagent comprises red blood cells comprising a known blood group antigen and the analyte is an antibody of a serum which is liable to bind with said antigen. This analysis particularly makes it possible to determine the presence and nature of an immune type antibody prior to a transfusion.

Within the scope of these two particular examples, an embodiment of the substance 5 capable of binding specifically with any complexes formed is for example formed from human anti-immunoglobulin antibodies (HGA) of monoclonal and/or polyclonal origin, possibly supplemented with antibodies directed against complement type serum protein determinants.

In this way, in the case of a positive reaction, a sheet of a complex covering the reactive surface 8 is observed and, otherwise, a negative spot is observed in the base 7 of the second compartment 4.

An example of an embodiment of the biological substance forming the temporary separation barrier 2 is described below.

In this example, the biological substance is presented, in its first state, in the form of a solid gel or a gel of dense texture and, in its second state, in the form of a liquid.

A biological substance formed from a mixture of sodium alginates, bovine albumin, sodium pyrophosphate and calcium chloride is used.

The interactions between these different compounds are not fully known, however, it can be suggested that alginate chains interact via their hydrophobic zones with albumin molecules and via their guluronic acid zones with calcium ions. Sodium pyrophosphate makes it possible to control the polymerisation reaction between the calcium and alginate which, without it, would be too quick to produce a gel with homogeneous cross-linking.

The biological substance is introduced into the container 1 in liquid form and gelling is then obtained after an incubation time of over one hour.

This gelling time enables the fluid to be well distributed over the substance 5 with a good surface state.

The gel obtained in this way enables the distribution of the reaction medium in the first compartment 3 at rates of the order of 400 ul/sec without inducing a leakage of reaction medium into the second compartment 4.

The transition between the first state and the second is carried out by a change of phase of the biological substance which is triggered by a specific chemical substance.

The specific chemical substance capable of depolymerising the gel described above is an agent complexing divalent ions, for example EDTA or sodium citrate, which triggers its liquefaction.

Indeed, the sodium alginates used have the property of forming, in the presence of divalent ions, a dense network (first state of the biological substance). However, this network is reversible since, in the presence of agents complexing the divalent ions, a rearrangement and/or dissociation of alginate chains triggering a liquefaction of the gel (second state of the biological substance) is observed.

The kinetics of this liquefaction is associated with the complexing agent concentration, the temperature and stirring, if applicable.

From the moment at which is gel is completely liquefied, there is nothing to oppose the transfer of at least the reaction product from the first compartment 3 to the second compartment 4.

This transfer may take place under the effect of three forces, used in combination or separately:

gravity, by natural settling of the reaction product;

suitable centrifugal forces;

magnetic forces if at least the reaction product has paramagnetic properties.

If the transfer is carried out under the effect of gravity and/or a centrifugal force, the density of the biological substance in the second state may be different to the constituents to pass through the barrier 2. For example, the density of the biological substance may be between that of the reaction product and that of the reagent so that, on the one hand, the reagent remains in the first compartment 3 and, on the other, at least the reaction product passes into the second compartment 4.

In an alternative embodiment, the density of the biological substance in its second state may have a gradient following a longitudinal direction.

The separation may also be obtained through a difference in physico-chemical affinity, for example through a difference in miscibility, between the biological substance, on the one hand, and the reaction product or the reagent, on the other.

In all these embodiments, the purpose of the biological substance in its second state, due to its density and/or its composition, is to enable, under the effect of external forces, the passage of at least the reaction product in order to enable the test to be carried out in the second compartment 4.

In the case of a transfer using a magnetic force, this function may be desirable, in order to prevent the transfer of the reaction product from carrying, particularly by means of a drainage effect, the reagent into the second compartment 4.

In an alternative embodiment, the barrier 2 may also comprise a product active in carrying out and/or detecting the reaction between the reagent and the analyte, for example in the form of an enzyme solution which is released in the reaction medium when the biological substance changes to its second state.

The preparation of the biological barrier 8 presented above is described below.

### Preparation of Different Solutions

### Sodium Alginate and Tetra-Sodium Pyrophosphate Solution

A partially hydrolysed (manuronic acid/guluronic acid ratio between 0.8 and 1) 1.2% (weight/volume) sodium alginate and 15 mM tetra-sodium pyrophosphate solution is prepared by dissolving a dry extract of commercial alginates and sodium pyrophosphate in a LISS (Low Ionic Strength Solution) buffer. In order to ensure perfect dissolution of the product, vigorous stirring is carried out. Any bubbles formed are eliminated using slower stirring. This solution is stored at 4° C. Before use, the solution is returned to ambient temperature.

### Albumin Solution

A 150 g/l albumin solution is prepared by diluting a 300 g/l commercial albumin preparation with LISS half-buffer. This solution is stored at 4° C. Before use, the solution is returned to ambient temperature.

### Calcium Chloride Solution

A calcium chloride solution in LISS buffer at a concentration of 10 mM is used. This solution is stored at 4° C. Before use, the solution is returned to ambient temperature.

### Tetra-Sodium EDTA Solution

A tetra-sodium ethylene diamine tetra-acetic acid solution is LISS buffer is prepared at a concentration 100 mM. The pH of this solution is adjusted to 7. This solution is stored at 4° C. Before use, the solution is returned to ambient temperature.

### Gel Preparation

The extemporaneous mixture before use is produced in a precise order.

Firstly, a volume for volume mixture of the alginate and pyrophosphate solution and the albumin solution is produced. After slow stirring for a few minutes, one volume of the calcium chloride solution is added to one volume of this solution. This mixture is homogenised rapidly and then distributed into the micro-wells 1 at a rate of 100 μl per well before the onset of gelling so as to cover the layer of HGA 5 completely (the preparation and handling time of such a product must not exceed thirty minutes). A minimum incubation period of one hour makes it possible to obtain a translucent and resistant gel.

In addition, the gelling step is carried out sufficiently slowly to enable easy industrialisation of the device and the absence of washing enables its easy and possibly fully automated implementation.

The micro-well 1 is then ready to use and must be stored at 4° C.

### Gel Depolymerisation

Gel depolymerisation is obtained by distributing approximately 50 μl per well 1 of a solution containing 100 mM of EDTA (other products complexing calcium ions may also be used). Complete liquefaction of the gel is obtained after incubation for approximately 15 minutes at a temperature of 20° C.

The preparation and distribution of the barrier 2 of biological substance are thus carried out in one step and mixing the various constituents of said barrier 2 in a precise order at given concentrations makes it possible to obtain a homogeneous gel throughout wherein the depolymerisation is perfectly controllable and simply takes place in the axis of the micro-well 1.

The steps of the method to conduct a test in the reaction container 1 described above are described below; said method comprising steps consisting of:

introducing the reaction medium into the first compartment 3;

changing the substance forming the barrier from its first state to its second state;

applying an external force capable of enabling the passage of one of the constituents such as the reagent, analyte and the reaction product from the first compartment to the second compartment via the barrier 2 of substance in its second state;

detecting the positive or negative nature of the test.

According to a first embodiment, the transition of the substance from its first state to its second state is carried out by introducing the specific chemical substance into the first compartment 3.

According to a second embodiment, the transition of the substance from its first state to its second state is carried out by activating the specific chemical substance, for example by means of radiation.

This embodiment applies equally well when the specific chemical substance has been introduced into the first compartment and when said substance is present in the barrier.

In an alternative embodiment, the method comprises a prior step consisting of arranging the biological barrier 2 inside the container 1.

In one example of an embodiment, the reagent and the specific chemical substance may be introduced simultaneously such that the reactions between the analyte and the reagent, on the one hand, and between the biological substance and the chemical substance, on the other, are carried out simultaneously.

Prior to the application of the external force, the reaction mixture present in the first compartment 3 may be subjected to conditions favouring the reaction between the analyte and the reagent, for example, incubation so as to increase the rate of the reactions to take place.

In a first embodiment, the external force comprises a centrifugal force, wherein the intensity, direction and duration are adjusted to enable the transfer of the desired constituents.

In a second embodiment, the external force comprises, in addition to a centrifugal force if applicable, a magnetic force.

The magnetic force is created for example, by a permanent magnet or by an electro-magnet, in a roughly longitudinal direction with respect to the container 1.

To this end, the constituents to pass through the barrier must be or must be rendered sufficiently paramagnetic to migrate from the first compartment 3 to the second compartment 4 under the effect of the magnetic force.

A first and second examples of analysis carried out with this method are described below.

In the first example, it is desired, using red blood cells wherein the group and phenotype are known, to detect and determine the nature of an immune type antibody, i.e. developed following an immunisation during a blood transfusion or a pregnancy. The presence of such antibodies may severely compromise any additional transfusion of noncompatible blood in the system in question and in the case of pregnancy may have severe consequences on the survival of the foetus. This standard analysis is referred as the Irregular Agglutinin Test (IAT).

To conduct this type of analysis, the reagent comprises red blood cells comprising a known blood group antigen and the analyte is an antibody liable to bind with said antigen.

The operator then deposits in the first compartment 3 one volume of serum or biological medium under study (approximately 25 μl) and two volumes of red blood cell indicator solution, for example previously treated with paramagnetic particles. In an alternative embodiment, this solution may comprise the agent depolymerising the gel.

The operator then places the micro-plate or the strip on a suitable shape enabling if required incubation at 37° C. and the whole is then subjected to a magnetic field and/or a centrifugal force.

When they come into contact with the HGA layer 5, the antibodies bound specifically with the red blood cell surface antigens interact with the antibodies adsorbed on the internal wall 6 of the container 1.

In this way, in the case of a positive reaction, an image of red blood cell sheets wherein the homogeneity and sizes will depend on the quantity of antibodies to be detected will be formed. If the reaction is negative, a central red blood cell spot will appear in the base 7 of the container 1.

In the second example, it is desired to determine the group and phenotype of the red blood cell and in this case specific probes (monoclonal or polyclonal antibodies, plant lectins) for certain blood group determinants.

For this purpose, the analyte is a red blood cell comprising a blood group antigen and the reagent may comprise a known antibody which is liable to bind with said antigen.

The implementation of the analysis is in this case identical to that described above except for the fact that, if a magnetic force is used, the red blood cells under analysis may be processed so as to increase their magnetic susceptibility.

The barrier 2 makes it possible, in the course of an analysis, to produce temporary isolation of the reaction medium in the first compartment 3 in order to enable the reaction or a treatment of the reaction medium to be carried out and then, at the desired time, to pass part of the constituents present in the reaction medium selectively to a second compartment 4 in order to enable the detection of the positive or negative nature of the analysis or enable the desired constituents to be placed into contact with a reagent placed in the barrier 2 and/or in the second compartment 4.

In addition, the barrier 2 enables:

a sequential analysis or a distribution sequence of the reaction medium prior to the contact of the reaction product with a substance;

the protection of a reactive zone of the second compartment 4 which contains a fragile or excessively reactive substances to be protected at the start of the analysis;

prevention of potential contamination of a reactive zone of the second compartment 4 by the reaction medium.

Due to its fluidity during its use in the container 1, the barrier 2 may be used in containers 1 of any shape and wherein current solutions are not satisfactory.

1. Temporary separation barrier (2) of a reaction container (1) consisting of at least one first compartment (3) wherein a reaction medium comprising an analyte and, if applicable, a reagent is introduced and a second compartment (4) intended to receive at least one of the constituents such as the reagent, analyte and the reaction product, said barrier (2) being characterised in that it is formed from a substance capable of changing, by means of the action of a specific chemical substance, from a first state wherein said substance is more or less impermeable to the reaction medium to a second state wherein said substance is liable to allow at least one of said constituents, such as the reagent, analyte and the reaction product, to pass.

2. Barrier according to claim 1, characterised in that the substance is presented, in its first state, in the form of a solid gel and, in its second state, in the form of a liquid.

3. Barrier according to claim 2, characterised in that the substance is biological in nature formed from a mixture of sodium alginates, bovine albumin, sodium pyrophosphate and calcium chloride so as to form a gel with homogeneous cross-linking, the specific chemical substance being an agent complexing divalent ions, for example EDTA, capable of liquefying said gel.

4. Barrier according to any of claims 1 to 3, characterised in that the density of the substance in the second state is different to that of the constituents to pass through the barrier (2).

5. Barrier according to any of claims 1 to 4, characterised in that it also comprises a product active in carrying out and/or detecting the reaction between the reagent and the analyte.

6. Barrier according to any of claims 1 to 5, characterised in that it also comprises the specific chemical substance.

7. Reaction container (1) comprising a barrier (2) according to any of claims 1 to 6, said container taking the form of a micro-well of a micro-titration plate, said micro-well having a U or V shape.

8. Container according to claim 7, characterised in that a substance (5) capable of binding specifically with the reaction product is placed in the second compartment (4).

9. Container according to claim 8, characterised in that the second compartment (4) is filled with the substance forming the barrier (2) such that it is also used to protect the substance (5) capable of binding specifically with the reaction product.

10. Container according to any of claims 7 to 9, characterised in that the second compartment (4) comprises a reagent.

11. Method to conduct a test in a reaction container (1) according to any of claims 7 to 10, said method comprising steps consisting of:
introducing the reaction medium into the first compartment (3);
changing the substance forming the barrier (2) from its first to its second state;
applying an external force capable of enabling the passage of one of the constituents such as the reagent, analyte and the reaction product from the first compartment (3) to the second compartment (4) via the barrier (2) of substance in its second state;
detecting the positive or negative nature of the test.

12. Method according to claim 11, characterised in that the transition from the first state to the second state is carried out by introducing the specific chemical substance into the first compartment (3).

13. Method according to claim 11 or 12, characterised in that the transition from the first state to the second state is carried out by activating the specific chemical substance, for example by means of radiation.

14. Method according to any of claims 11 to 13, characterised in that the potential reaction between the reagent and the analyte takes place in the first compartment (3) and the detection of the potential reaction is carried out in the second compartment (4), the substance in its second state being in this case capable of allowing at least the reaction product to pass.

15. Method according to any of claims 11 to 14, characterised in that it comprises a prior step consisting of arranging the biological barrier (2) inside the container (1).

16. Method according to any of claims 11 to 15, characterised in that the reagent comprises red blood cells comprising a known blood group antigen and the analyte is an antibody liable to bind with said antigen, the method particularly making it possible to determine the presence and nature of an immune type antibody prior to a transfusion.

17. Method according to any of claims 11 to 15, characterised in that the analyte is a red blood cell comprising a blood group antigen and the reagent comprises a known antibody which is liable to bind with said antigen, the method particularly making it possible to determine the group or phenotype of the red blood cell.
